(19) United States
(12) Patent Application Publication
(10) Pub. No.: US 2006/0118680 A1
(43) Pub. Date: Jun. 8, 2006

(54) Display stand

(75) Inventor: Ching-Hui Yen, Kaohsiung City (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/293,244

(22) Filed: Dec. 5, 2005

(30) Foreign Application Priority Data
Dec. 7, 2004 (TW) 93137766

(51) Int. Cl. F16L 3/00

(52) U.S. Cl. 248/121

(57) ABSTRACT

A display stand. A spring is disposed on a fixed bracket, and a slidable bracket is capable of sliding on the fixed bracket. A pulley is disposed on the slidable bracket, and a wire can slide on the pulley with one end connected to the fixed bracket and the other end connected to the spring.

### BACKGROUND

The invention relates to a display stand, and in particular to a display stand utilizing a pulley to share the weight of the display so as to reduce the number of springs used in the display stand.

Referring to FIG. 1, a display stand 100 is used to support a display (not shown). The display stand 100 comprises a fixed bracket 104 and a slidable bracket 102 capable of sliding on a fixed bracket 104, thereby adjusting height of the display. Two constant force springs 106 are disposed on the fixed bracket 104 with one end connected to the front of the slidable bracket 102 so as to support the slidable bracket 102, thereby the display can be positioned at an arbitrary height. In a constant force spring, when the elongation thereof exceeds a predetermined value, the restoring force Fs is a constant. Only if the difference of the restoring force Fs and the weight W of the display is less than the maximum static friction fmax, i.e. Fs-W<fmax, the static position of slidable bracket 102 is maintained. As the restoring force Fs of a constant force spring is constant with respect to arbitrary elongations, the slidable bracket 102 can be maintained static at an arbitrary position. As the display size is enlarged, the weight thereof is increased such that multiple constant force springs must be used. In FIG. 1, two constant force springs are parallely connected to support the weight. The constant force spring 106 in FIG. 1 typically formed by a coiled metal stripe has a large volume. The volume of the display stand 100 is thus increased if multiple constant force springs 106 are used.

### SUMMARY

A display stand according to an embodiment of the invention comprises a fixed bracket, a spring, a slidable bracket, a pulley and a wire. The spring is disposed on the fixed bracket, and the slidable bracket is capable of sliding on the fixed bracket. A pulley is disposed on the slidable bracket, and a wire can slide on the pulley with one end connected to the fixed bracket and the other end connected to the spring.

### BRIEF DESCRIPTION OF THE DRAWINGS

The invention can be more fully understood by reading the subsequent detailed description and examples with references made to the accompanying drawings, wherein:

FIG. 1 is a perspective view of a conventional display stand;

FIG. 2a is a perspective view of a display stand according to an embodiment of the invention;

FIG. 2b is a force diagram of a pulley according to an embodiment of the invention; and

FIGS. 3a, 3b, 4a, 4b are schematic views depicting motion of a display stand according to an embodiment of the invention.

### DETAILED DESCRIPTION

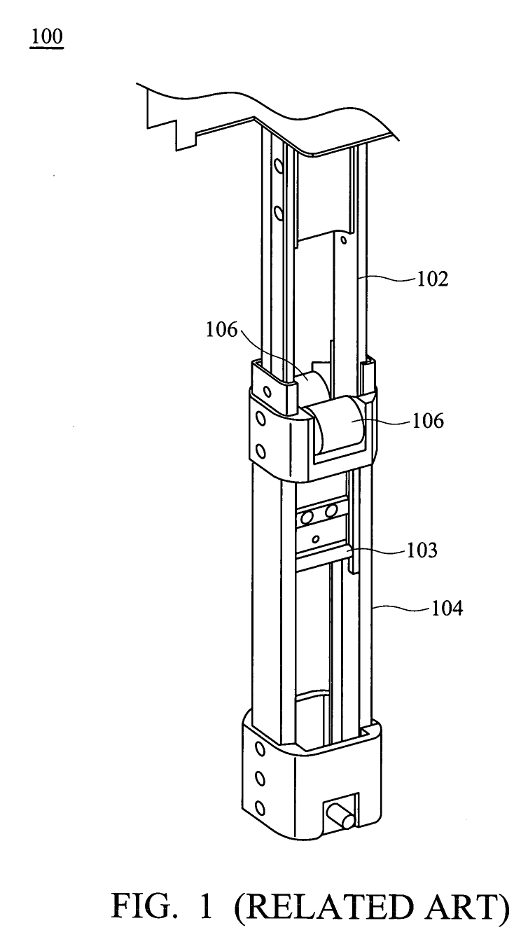

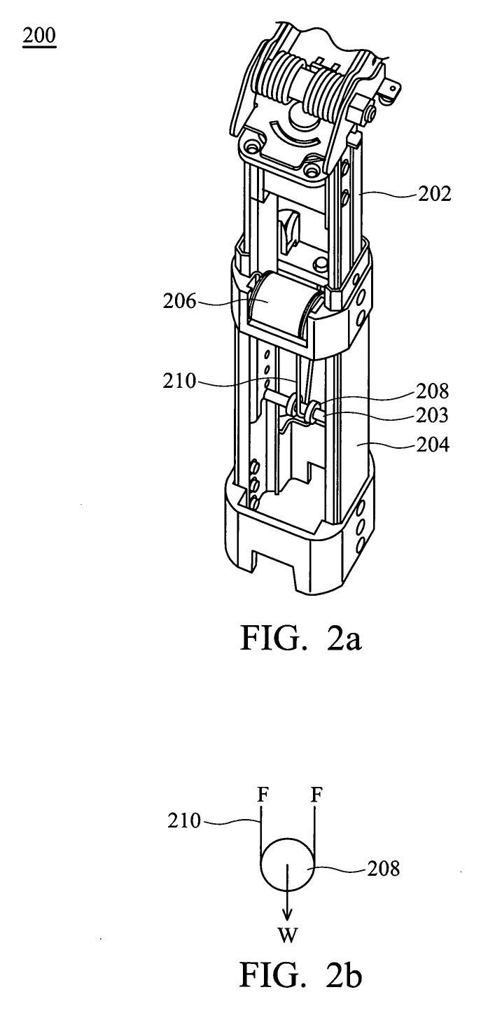

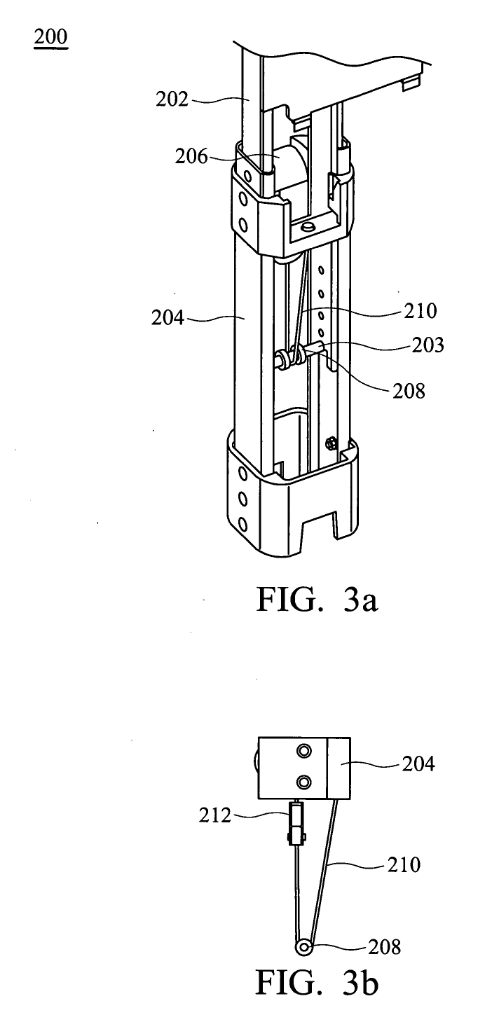

Referring to FIG. 2, a display stand 200 according to a embodiment of the invention comprises a slidable bracket 202, a fixed bracket 204, a constant force spring 206, a pulley 208 and a wire 210. The fixed bracket 204 is fixed to a surface, and the slidable bracket 202 is capable of sliding on the fixed bracket 204. The constant force spring 206 is disposed on the fixed bracket 204, and the pulley 208 is pivoted at a rod 203 disposed on the front of the slidable bracket 202. The wire 210 winds around the pulley 208 with one end connected to the fixed bracket 204 and the other end connected to the constant force spring 206. FIG. 2b depicts force exerted on the pulley 208. The weight of the display is supported by the fixed bracket 204 and the constant force spring 206 along with the pulley 208 and the wire 210. Only one constant force spring 206 is needed in the display stand 200 of FIG. 2a. Compared with the conventional display stand of FIG. 1, the number of constant force springs is thus reduced.

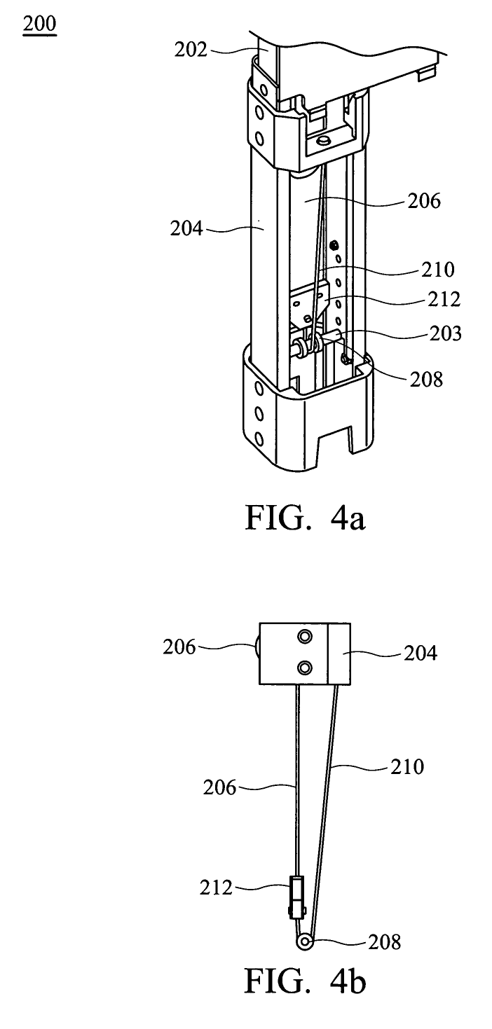

FIGS. 3a, 3b, 4a and 4b depict motion of the constant force spring 206, the wire 210 and the pulley 208. As shown in FIGS. 3a and 3b, the wire 210 is connected to the constant force spring 206 via a connector 212. In FIGS. 4a and 4b, the constant force spring 206 is elongated when the slidable bracket 202 moves downward. The displacement of the slidable bracket 202 is reflected by the elongation of the constant force spring 206.

The stand of the invention is not limited to be used in a display, it can also be applied to other electronic devices.

The stand of the invention utilizes a pulley and a wire to share the weight of a display, thereby reducing the number of spring used in the stand to decrease the volume of the stand.

While the invention has been described by way of example and in terms of embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display stand, comprising:
a fixed bracket;
a spring disposed on the fixed bracket;
a slidable bracket capable of sliding on the fixed bracket;
a pulley disposed on the slidable bracket; and
a wire sliding on the pulley with one end connected to the fixed bracket and the other end connected to the spring when the slideable bracket slides.

2. The display stand as claimed in claim 1 further comprising a connector connecting the wire and the spring.

3. The display stand as claimed in claim 1, further comprises a rod fixed at the front of slidable bracket, and the pulley is pivoted on the rod.

4. The display stand as claimed in claim 1, wherein the spring is a constant force spring.

5. The display stand as claimed in claim 1, wherein the wire is a steel wire.

6. A display, comprising:
a main body;
a fixed bracket;
a spring disposed on the fixed bracket;
a slidable bracket joined with the main body and capable of sliding on the fixed bracket;
a pulley disposed on the slidable bracket; and
a wire sliding on the pulley with one end connected to the fixed bracket and the other end connected to the spring when the slideable bracket slides.

7. The display as claimed in claim 6 further comprising a connector connecting the wire and the spring.

8. The display as claimed in claim 6 further comprises a rod fixed at the front of the slidable bracket, and the pulley is pivoted on the rod.

9. The display as claimed in claim 6, wherein the spring is a constant force spring.

10. The display as claimed in claim 6, wherein the wire is a steel wire.
